(19) United States
(12) Patent Application Publication
(10) Pub. No.: US 2023/0399234 A1
(43) Pub. Date: Dec. 14, 2023

(54) SYNTHESIS OF NANO-SIZED ZEOLITES

(71) Applicant: University of Houston System, Houston, TX (US)

(72) Inventors: Jeffrey D. Rimer, Bellaire, TX (US); Deependra Parmar, Houston, TX (US); Adam Mallette, Houston, TX (US)

(73) Assignee: University of Houston System, Houston, TX (US)

(21) Appl. No.: 18/334,678

(22) Filed: Jun. 14, 2023

Related U.S. Application Data
(60) Provisional application No. 63/352,021, filed on Jun. 14, 2022.

(51) Int. Cl. C01B 39/48

(52) U.S. Cl. CPC C01B 39/48; C01P 2004/64

(57) ABSTRACT

Nano-sized zeolites may be prepared using germanium oxide (GeO₂) as a component of the overall synthesis composition. This is accomplished by the addition of GeO₂ as an inexpensive reagent for the synthesis gel. Most of the Ge is retained in the synthesis mixture and the small amount incorporated in the zeolite solid (Si/Ge>100) does not have an appreciable impact on zeolite acidity or other physicochemical properties. The methods disclosed herein circumvent challenges to prepare nano-sized zeolites having dimensions less than 100 nm.

This application claims priority to U.S. Provisional Patent Application Ser. No. 63/352,021, entitled “Synthesis of Nano-Sized Zeolites,” filed Jun. 14, 2022, the entire contents of which are hereby incorporated by reference.

This invention was made with government support under grant DE-SC0014468 awarded by the Department of Energy, Basic Energy Sciences. The government has certain rights in the invention.

### BACKGROUND

This disclosure pertains to synthesis of zeolites.

One of the main thrusts in zeolite science is designing synthetic routes that reduce diffusion limitations by generating crystals with smaller dimensions. This is particularly critical in catalysis where micron-sized crystals suffer from low catalyst stability owing to rapid coke build-up during reactions. Synthesizing nanosized zeolites, however, is non-trivial since methods for establishing a priori control over crystal dimensions are generally lacking. Furthermore, fewer than 30 zeolite frameworks that have been synthesized as nanoparticles, and many of these approaches require high concentrations of costly organic structure-directing agents (OSDAs), suffer from low product yields, and often have limited compositional ranges (i.e. Si/Al ratios) that can compromise their effectiveness for certain applications.

In literature, researchers have reported the synthesis of nano-sized zeolites with dimensions less than 100 nm for approximately 20 different zeolite frameworks (among the known 250 structures). Many of these synthesis methods are limited in their ability to generate zeolites with a Si/Al ratio that is suitable for commercial applications. For ZSM-5, the synthesis of nano-sized crystals (generally less than 200 nm) is predominantly limited to high silica compositions (i.e. Si/Al>30), which is outside the range of many commercial applications. For example, Si/Al is less than 25 for catalysts. For ZSM-11, which is similar to and often outperforms ZSM-5, crystal sizes less than 200 nm with sufficiently high Al content cannot be easily synthesized.

Challenges in zeolite crystal engineering motivate researchers to design facile, economical, and generalizable approaches to prepare nano-sized or hierarchical architectures to improve diffusion. Many diverse top-down and bottom-up synthesis protocols have been used to produce diverse pillared, finned, or two-dimensional structures, nanocrystals, and mesoporous materials. For commercial viability it is desirable to develop bottom-up approaches that are applicable to a broad range of crystal topologies, improve the overall efficiency of synthesis (e.g. reduced time and/or temperature, higher yields, etc.), and eliminate costly reagents.

### SUMMARY

The present disclosure relates generally to synthesis of zeolites.

Disclosed herein are methods for preparing nano-sized zeolites using germanium oxide (GeO₂) as a component of the overall synthesis composition. Zeolites are nanoporous crystalline materials that exhibit internal diffusion limitations to guest molecules, which often compromises their performance as catalysts and sorbents. Different strategies have been used to reduce mass transport limitations, including the synthesis of nano-sized crystals (some with sizes less than 100 nm), 2-dimensional nanosheets, and hierarchical materials with interconnected mesopores and micropores. These strategies often involve multi-step synthesis procedures and/or require the use of expensive organic molecules. Interestingly, few studies have strategically employed heteroatoms (e.g., elements other than Si or Al) in zeolite syntheses to tailor crystal size. The present disclosure relates to the use of germanium as a modifier of zeolite crystallization.

There has been increased interest in the incorporation of diverse heteroatoms in zeolites owing to their ability to alter the zeolite acidity and create bifunctional catalysts. Recent studies have also established that heteroatoms can be used to efficaciously modify crystallization kinetics and/or zeolite morphology. Germanium incorporation in zeolites has been utilized for two general applications. The first is the generation of extra-large pore zeolites, such as ITQ-37 (FIG. 1A), based on the propensity of GeO₂ tetrahedral units to promote the formation of composite building units (e.g. double-four-membered rings) that are essential to the topology of these frameworks. A second role of germanosilicates in zeolite synthesis is the insertion of Ge as sacrificial sites (FIG. 1A) that enable post-synthesis removal. FIG. 1A shows schematics of the role of Ge in zeolite synthesis where its ability to stabilize double 3- and 4-membered rings (d3r and d4r) facilitates the formation of extra-large pore germanosilicate zeolites, such as ITQ-37 (-ITV). This phenomenon is critical to the assembly-disassembly-organization-reassembly (ADOR) process that is used to synthesize new zeolite frameworks. It is also utilized in the preparation of layered (or 2-dimensional) materials.

In particular, the present disclosure relates to a method to reduce the size of conventional zeolites of different crystal structures via the addition of GeO₂ to synthesis gels. For example, synthesis gels are used that have molar ratios of Si/Ge greater than or equal to 10. The presence of germanium reduces the crystal size of zeolite ZSM-11 (MEL framework) by a factor of 8 (i.e. from 400 to 50 nm). Similar outcomes were observed for zeolite ZSM-5 (MFI framework) where the addition of germanium resulted in an increased population of nanoparticles (<50 nm).

The addition of GeO₂ to syntheses of mordenite (MOR framework) alters crystal morphology from large particles (>5 μm) to intergrown layers (with layer thickness <200 nm). As the synthesis conditions of zeolite frameworks are different, this highlights the generalizability of this method for diverse synthesis conditions and zeolite crystal structures. The insertion of Ge in zeolite frameworks can stabilize smaller rings (<5-member ring); however, most of the Ge added to these syntheses is not incorporated in the final crystalline product. For example, Si/Ge is generally greater than 100 in the final product. Thus, a majority of Ge can be recovered and reused, which can be commercially beneficial for the preparation of nano-sized zeolite crystals. In certain cases, such as ZSM-11, the use of GeO₂ as described herein leads to higher product yields. Analysis of nano-sized H-ZSM-11 and H-ZSM-5 catalysts prepared from GeO₂-containing syntheses also reveal enhanced catalyst lifetime in the methanol to hydrocarbons reaction compared to samples prepared by conventional synthesis methods.

The use of GeO₂ essentially as a zeolite growth modifier, as described herein, provides a versatile approach to synthesize nano-sized zeolites. GeO₂ has been used to synthesize germano(alumino)silicates where germanium usually resides in small rings in zeolite/zeotypes frameworks, such as double-3-member rings (d3r) and double-4-member rings (d4r), which are connected to form 3-dimensional zeolite structures. The Ge in these rings can be easily removed by post-treatment methods, such as the assembly, disassembly, organization, and reassembly (ADOR) process to form new zeolites frameworks. However, there are no existing technologies that use GeO₂ as a growth modifier for one-step synthesis to reduce the size and/or alter the morphology of zeolite crystals to improve their diffusional properties. The methods described herein allow for zeolite synthesis wherein the reagent GeO₂ is added in small quantity (relative to SiO₂) to a synthesis gel. This method can be applied to different synthesis conditions and multiple zeolite frameworks with the ability to recover the majority of germanium oxide after synthesis.

Using Ge as a crystal growth modifier is in stark contrast to its common use as a heteroatom. This unique strategy is applied to syntheses of two commercially-relevant zeolites (MFI and MEL) as a facile method to generate nano-sized dimensions. This approach is generalizable and Ge-assisted syntheses produce materials with exceptional catalytic performance relative to conventional analogues. The ability to manipulate crystal morphology using readily available inorganics is appealing because it offers significant potential to generate optimal materials using a scalable and highly tunable strategy.

### BRIEF DESCRIPTION OF THE DRAWINGS

FIG. 1A shows schematics of the role of Ge in zeolite synthesis to facilitate formation of extra-large pore germanosilicate zeolites.

FIG. 1B shows crystal structures and composite building units of MEL and MFI frameworks.

FIGS. 1C-1F show time-elapsed powder XRD patterns of (C and D) ZSM-11 (MEL) and (E and F) ZSM-5 (MFI) syntheses.

FIG. 2A shows a scanning electron micrograph of as synthesized ZSM-11.

FIG. 2B shows a scanning electron micrograph of as synthesized Ge-ZSM-11.

FIG. 3A shows powder X-ray diffraction patterns showing the crystallinity of ZSM-11, Ge-ZSM-11, and the germanium oxide phase (from direct synthesis).

FIG. 3B shows scanning electron micrograph of germanium oxide crystals prepared from a MEL synthesis where both Si and Al sources are removed.

FIG. 4A shows a scheme showing the dissolution of Ge-zeolite seeds, releasing Ge species into a growth medium that is initially Ge-free.

FIG. 4B shows a scanning electron micrograph of ZSM-11_{seed}.

FIG. 4C shows a transmission electron micrograph of a representative ZSM-11_{seed} crystal.

FIG. 4D shows a scheme showing the dissolution of Ge-zeolite seeds, releasing Ge species into a growth medium that contains GeO₂.

FIG. 4E shows a SEM image of Ge-ZSM-11_{seed}.

FIG. 4F shows a TEM image of a representative Ge-ZSM-11_{seed} crystal.

FIG. 5A shows scanning electron micrograph of a ZSM-11_{Al-rich} sample.

FIG. 5B shows a SEM image of a Ge-ZSM-11_{Al-rich} sample.

FIG. 5C shows an electron diffraction pattern of Ge-ZSM-11_{Al-rich} showing evidence of polycrystallinity.

FIG. 5D shows a TEM image of a representative Ge-ZSM-11_{Al-rich} particle. Inset is a high resolution image of the dashed box showing individual nanocrystals.

FIG. 6A shows a scanning electron micrograph of ZSM-5.

FIG. 6B shows a transmission electron micrograph of ZSM-5 showing rough features that are characteristic of crystallization by amorphous precursor attachment.

FIG. 6C shows a SEM image of Ge-ZSM-5 showing a highly corrugated particle surface.

FIG. 6D shows a TEM image of a representative Ge-ZSM-5 particle showing evidence of growth by either colloidal assembly or (nearly)oriented attachment.

FIG. 7A shows methanol conversion as a function of time on stream for H-form ZSM-5 (squares) and Ge-ZSM-5 (circles) catalysts in a methanol-to-hydrocarbon (MTH) reaction carried out at 350° C., 1 atm, and WHSV=50 h⁻¹.

FIG. 7B shows a comparison of deactivation rates from reactions at sub-complete methanol conversion for zeolites synthesized with and without GeO₂.

FIGS. 7C and 7D show total product selectivities for catalysts (C) ZSM-5 and (D) Ge-ZSM-5 as a function of time on stream at sub-complete conversion.

### DETAILED DESCRIPTION OF PREFERRED EMBODIMENTS

The present disclosure relates to synthesis of zeolites, particularly to synthesis of nano-sized zeolites using germanium oxide as a zeolite growth modifier.

Preferred embodiments of the methods disclosed herein circumvent challenges to prepare nano-sized zeolites (e.g., ZSM-5 and ZSM-11) with higher aluminum content (e.g., Si/Al=15-20), without the addition of exotic organics or multi-step procedures that are common to conventional methods. In preferred embodiments, this is accomplished by the addition of GeO₂ as an inexpensive reagent for the synthesis gel. Most of the Ge is retained in the synthesis mixture and the small amount incorporated in the zeolite solid (Si/Ge>100) does not have an appreciable impact on zeolite acidity or other physicochemical properties. The methods described herein are robust in that they can be applied to the synthesis of different frameworks under diverse synthesis conditions to produce zeolites with a wide range of Si/Al ratios. The synthesized materials are commercially relevant zeolites for applications in the petroleum and (petro)chemical industries.

As used herein, the term “nano-sized zeolites” refers to zeolites having dimensions less than 100 nm.

Preferred embodiments described herein relate to methods for synthesizing nano-sized zeolites using germanium oxide as a zeolite growth modifier. The method includes preparing a synthesis mixture comprising at least silica, aluminum, and germanium, where the ratio of silica to germanium in the synthesis mixture is at least 10. The synthesis mixture is heated to 100° C. to 200° C. and may optionally be stirred and allowed to age for a period of time, which allows nano-sized zeolites to form in the synthesis mixture. An additional step in preferred embodiments may include washing the zeolites after isolating. The zeolites isolated from the synthesis mixture include nano-sized zeolites, and the ratio of silica to germanium in the nano-sized zeolites after washing is at least 100.

In further preferred embodiments, the synthesis mixture may also comprise one or more of 1,8-diaminooctane, tetrabutylammonium bromide, and tetrapropylammonium hydroxide as an organic structure directing agent. Preferred embodiments may also include a step of adding nano-sized zeolite crystals comprising germanium to the synthesis mixture as seed crystals. In additional preferred embodiments, there may be a step of annealing the nano-sized zeolites after isolating to improve catalytic performance. Preferred embodiments may also include a step of calcining the nano-sized zeolites after they are isolated to remove organic templates and produce calcined zeolites. Additional preferred embodiments may include a step of ion exchanging the calcined zeolites to produce proton-form nano-sized zeolites. In some preferred embodiments a ratio of silica to aluminum in the nano-sized zeolites is 15 to 30. The nano-sized zeolites may be MEL type or MFI type in additional preferred embodiments. Further preferred embodiments of the method may include a step of recovering germanium from the synthesis mixture after isolating the nano-sized zeolites. The germanium may be recovered after the washing step.

Additional preferred embodiments described herein include the nano-sized zeolites prepared by the method described above. Further preferred embodiments include a catalyst comprising the nano-sized zeolites prepared by the method described above. Preferred embodiments also include a method for preparing or converting an organic compound comprising contacting the organic compound with the catalyst that comprises the nano-sized zeolites. The method for preparing or converting an organic compound may include performing alkylation, Fischer-Tropsch synthesis, methanol or methane upgrading, cracking, or biomass conversion.

Further aspects of the present invention will become apparent from the following description given by way of example only.

### EXAMPLE 1

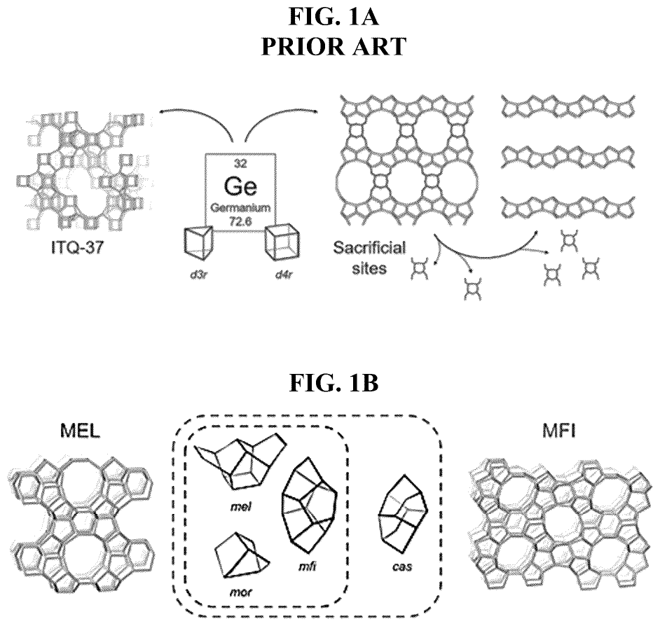

Two framework types, MEL and MFI, with similar structures (FIG. 1B) were selected to assess the effects of GeO₂ as a modifier of zeolite crystallization. For syntheses in the absence of modifier, established protocols were used to prepare ZSM-11 (MEL) and ZSM-5 (MFI) (Y. Shen, ACS Catal. 2018; Y. Shen, ChemPhysChem 2018) with Si/Al ratios spanning from 15 to 30 and synthesis temperatures of 160 and 170° C., respectively.

Materials. The following reagents were used for zeolite synthesis as purchased from Sigma Aldrich without further purification: Ludox AS-30 colloidal silica (30 wt % suspension in water), tetraethylene orthosilicate (TEOS, 98%), sodium aluminate (anhydrous), aluminum sulphate hydrate (Al₂(SO₄)₃·18H₂O, >98%) sodium hydroxide (98% pellets), potassium hydroxide (>99%), 1,8 diaminooctane (CsDN, >98%), tetrabutyl ammonium bromide (TBABr, >99%), tetrapropyl ammonium hydroxide (TPAOH, 40 wt %), germanium oxide (>99%) and ammonium nitrate (>98%). Deionized (DI) water was produced with an Aqua Solutions purification system.

Zeolite synthesis. ZSM-11 was synthesized according to a reported protocol (Y. Shen, T. T. Le, R. Li, J. D. Rimer, ChemPhysChem 2018, 19, 529). The molar composition of 1 Al₂O₃:90 SiO₂:11.9 K₂O:27.3 CsDN:3588 H₂O was used. In a typical synthesis, solutions of each component were prepared separately: KOH solution was prepared by dissolving potassium hydroxide (0.21 g, 3.13×10-3 mol) in water (0.91 g); aluminium solution was made by dissolving aluminum sulfate (0.089 g, 1.32×10-4 mol) in water (0.91 g); CsDN (0.53 g, 3.6×10-3 mol) was dissolved in water (3.64 g); and LUDOX AS-30 (2.37 g, 11.84×10-3 mol) mixed with water (1.35 g) was introduced as a colloidal suspension. The KOH, OSDA (CsDN, or 1,8-diaminooctane) and A1₂(SO₄)₃ solutions were first mixed together and stirred for ca. 5 min to generate a uniform mixture. The silica suspension was then added dropwise under constant stirring. The resulting mixture was left to stir overnight (ca. 21 h) at room temperature. After aging was complete, the growth mixture (ca. 10 g) was placed in a Teflon-lined stainless steel acid digestion bomb (Parr Instruments) and was heated under static conditions in an oven at 160° C. for 3 days and autogenous pressure. Ge-ZSM-11 was synthesized with same growth mixture as ZSM-11 with addition of 0.124 g of GeO₂ as germanium source to make the composition of Si/Ge=10 in synthesis gel. 1 g of ethylene glycol was added to growth solution to increase the solubility of GeO₂.

ZSM-1_{seed} was synthesized with the same synthesis gel composition as ZSM-11, with the addition of Ge-ZSM-11 crystals as seed (4 wt % of synthesis gel) at 120° C. for 3 days under rotation. Ge-ZSM-11_{seed} synthesis uses same growth solution as ZSM-11_{seed}, with further addition of GeO₂ (Si/Ge ratio=10) and ethylene glycol (1 g). ZSM-11_{Al-rich} was synthesized using TBABr (tetrabutylammonium bromide) as an organic structure directing agent. First, NaOH (0.36 g) was dissolved in the water (10.32 g), then the TBABr (0.32 g) was added and stirred for 10 minutes. After mixing, sodium aluminate, NaAlO₂ (0.1305 g) was added to the solution and stirred for 10 minutes more. Then, the colloidal silica (30 wt % SiO₂, 4.605 g) was added to the solution drop-wise while stirring. The whole growth solution was aged at room temperature for 6 hours. Finally, the growth solution was transferred to Teflon-lined stainless steel autoclave and was heated at 180° C. for 4 days under static conditions. The molar composition of synthesis gel was 1 Al:5.7 NaOH:14.5 SiO₂:0.6 TBABr:473 H₂O. The synthesis of Ge-ZSM-11_{Al-rich} is same as ZSM-11_{Al-rich}, with the addition of GeO₂ (Si/Ge ratio=10) in the synthesis gel.

ZSM-5 was synthesized using growth solution with molar composition of 100 Si:2.5 Al₂O₃:4 Na₂O:20 TPAOH:2800 H₂O. First, NaOH was dissolved in the water, then sodium aluminate and TPAOH (tetrapropylammonium hydroxide) were added and stirred until they dissolved as well. Then, TEOS (tetraethyl orthosilicate) was added drop-wise and the growth solution was aged at room temperature for 1 h under stirring. Finally, the growth solution was transferred to Teflon-lined autoclave and heated at 180° C. under static conditions for 4 hours. Ge-ZSM-5 was synthesized using the same protocol as ZSM-5, with the addition of GeO₂ with a Si/Ge ratio of 10.

ZSM-5 and Ge-ZSM-5 samples were annealed using a dilute basic solution with molar composition of 1 Si:1.4 TPAOH:900 H₂O, to improve their catalytic performance for methanol-to-hydrocarbon reaction. The zeolite powder (2 wt %) was mixed with annealing solution and was hydrothermally treated at 170° C. for 7 days under static conditions. After synthesis, all zeolites were washed with water using a centrifuge (until the pH reached 7) then dried in an oven at 50° C. overnight. As-synthesized samples were calcined at 550° C. for 8 h to remove the organic templates from the zeolite framework under an air flow of 50 sccm. The calcined samples were turned into their proton-form via ion exchanging the calcined materials with 1 M solution of ammonium nitrate for 2 h. This ion exchange procedure was repeated 3 times to ensure complete ion exchange. Finally, samples were calcined at 550° C. for 5 h with 1° C./min ramp rates to achieve proton-form of zeolite materials. To recover the Ge from all germanium containing zeolites, the as-synthesized samples were washed with water at 80° C. for 3 h with stirring.

Characterization. The crystallinity of the zeolite materials was characterized using powder X-ray diffraction (XRD) patterns using Rigaku diffractometer using Cu Kα radiation (40 kV, 40 mA). Scanning electron microscopy (SEM) images were taken using FEI 235 Dual-Beam system operated at 15 kV after coating the SEM samples with thin layer of carbon. Electron dispersive spectroscopy (EDS) was performed to quantify the elemental composition of zeolite materials using a JEOL SM-31010/METEK EDAX system operated at 12 kV and 15 mm working distance. Micromeritics 3Flex instrument (N₂ physisorption) was employed to quantify the porous properties of zeolites. The BET method was used to quantify total surface area, while the t-plot method was used to quantify external surface area and micropore volume. Thermo Scientific Nicolet 6700 FTIR spectrometer using pyridine as basic probe molecule was used to quantify the Brønsted and Lewis acid sites in zeolite materials. Firstly, the samples were pressed to thin wafers and were transferred to the FTIR sample cell. The samples were pretreated at 500° C. under Argon flow of 50 seem for 2 hours and then temperature was lowered to adsorption temperature of 200° C. The samples were saturated with pyridine and then evacuated for 1 hour before collecting the adsorption spectrum.

The samples for transmission electron microscope (TEM) investigations were dispersed in ethanol. After ultrasonication of the suspension, a droplet was taken and transferred to a lacey carbon copper grid. Then the droplet was dried in air at room temperature. TEM images and selected area electron diffraction (SAED) patterns were acquired using a JEOL JEM-2100F microscope operated at 200 kV (Cs 1.0 mm, point resolution 0.23 nm) with a Gatan Orius 200D CCD camera (resolution 2048×2048 pixels, pixel size 7.4 μm). 3D electron diffraction (3DED) and electron tomography datasets were collected on a double aberration-corrected Themis-Z TEM operated at 300 kV with a Gatan OneView camera. A beam current of 30 pA was used in order to minimize the beam damage.

FIGS. 1C-1F show time-elapsed powder XRD patterns of (C and D) ZSM-11 (MEL) and (E and F) ZSM-5 (MFI) syntheses (times of hydrothermal treatment are listed). Syntheses were performed in the absence (FIGS. 1C and 1E) and presence (FIGS. 1D and 1F) of GeO₂. Samples labelled “washed” were treated in DI water at 80° C. for 3 hours to remove germanium mineral impurity (labelled with asterisks). Powder X-ray diffraction (XRD) patterns of ZSM-11 (FIG. 1C) and ZSM-5 (FIG. 1E) reveal fully crystalline materials without observable impurities. Introduction of GeO₂ does not alter the crystallinity of either MEL (FIG. 1D) or MFI (FIG. 1F) but does lead to a minor impurity that can be removed by treatment in water at 80° C., analogous to the post-treatment ion-exchange protocol used to prepare H-form zeolites for catalytic testing. One noticeable difference among syntheses in the presence of GeO₂ is an approximate 24-hour reduction in the time required to reach full crystallinity for MEL, whereas the effect of GeO₂ on MFI synthesis was marginal. Textural and elemental analyses of all samples, shown in Table 1 below, indicates that synthesis in the presence of GeO₂ does not significantly alter the composition (Si/Al ratio), microporosity, and BET surface area of as-synthesized zeolites. Elemental analysis also reveals a minor quantity of Ge incorporated in the zeolites (i.e., Si/Ge>100 after washing), indicating that the majority of Ge added to the synthesis gel is retained in the supernatant or mineral impurities (isolated from the zeolite), thus allowing for the removal and potential recovery of GeO₂.

TABLE 1

| | | | BET surface area^{b} | | Micropore |
|---|---|---|---|---|---|
| | Composition^{a} | | (m² g⁻¹) | | volume^{c} |
| Catalyst | Si/Al | Si/Ge | Total | External | (cm³ g⁻¹) |
| ZSM-11 | 28 | — | 366 | 67 | 0.15 |
| Ge-ZSM-11_{AS} | 34 | 25 | 417 | 75 | 0.14 |
| Ge-ZSM-11 | 35 | 108 | 387 | 74 | 0.13 |
| ZSM-11_{seed} | 31 | — | 433 | 77 | 0.15 |
| Ge-ZSM-11_{seed, AS} | 28 | 61 | 427 | 108 | 0.13 |
| Ge-ZSM-11_{seed} | 29 | >500 | 415 | 100 | 0.13 |
| ZSM-11_{Al-rich} | 16 | — | 365 | 35 | 0.13 |
| Ge-ZSM-11_{Al-rich, AS} | 17 | 38 | 354 | 36 | 0.13 |
| Ge-ZSM-11_{Al-rich} | 18 | 82 | 363 | 70 | 0.12 |
| ZSM-5^{d} | 18 | — | 473 | 227 | 0.11 |
| Ge-ZSM-5^{d} | 18 | >500 | 386 | 170 | 0.09 |

^{a}Determined by elemental analysis (EDX);
^{b,c}N₂ adsorption/desorption data;
^{d}samples were annealed according to a reported protocol; samples are labelled as AS = as synthesized, seed = product of seeded growth, Al rich = synthesis at Si/Al (gel) = 15.

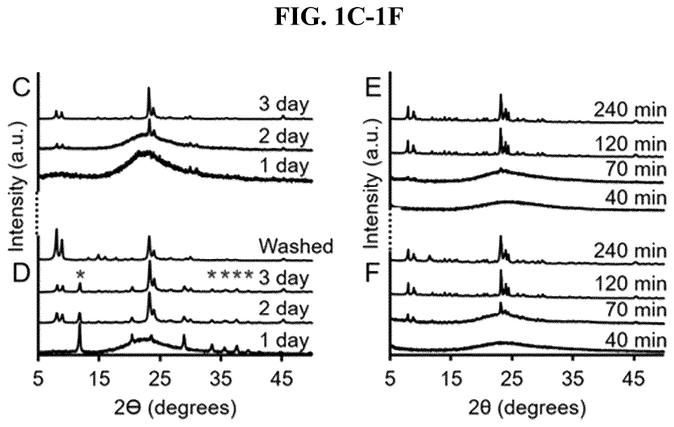

ZSM-11 was prepared using diaminooctane (DAO) as the organic structure-directing agent where prior studies have shown that synthesis under static conditions yields intergrown MEL crystals (with a relatively broad size distribution (100 nm-2 μm). FIG. 2A shows a scanning electron micrograph of as synthesized ZSM-11. The same synthesis recipe under conditions of rotation yields a different zeolite structure, ZSM-22 (TON), with needle-like morphology. Interestingly, the addition of GeO₂ to this synthesis mixture promotes the formation of Ge-ZSM-11 under rotation conditions, suggesting that germanium preferentially stabilizes the MEL structure. FIG. 2B shows a scanning electron micrograph of as synthesized Ge-ZSM-11.

Another key observation is that Ge-ZSM-11 crystals exhibit a uniform rod-like morphology with cross-sectional dimensions of 50-100 nm. Electron diffraction patterns confirm that Ge-ZSM-11 is fully crystalline. Elemental mapping of Ge-ZSM-11 crystals reveals that Ge is well-distributed throughout the particles. The reduced cross-section of Ge-ZSM-11 rods reduces the diffusion path length, thereby improving mass transport properties for catalytic applications.

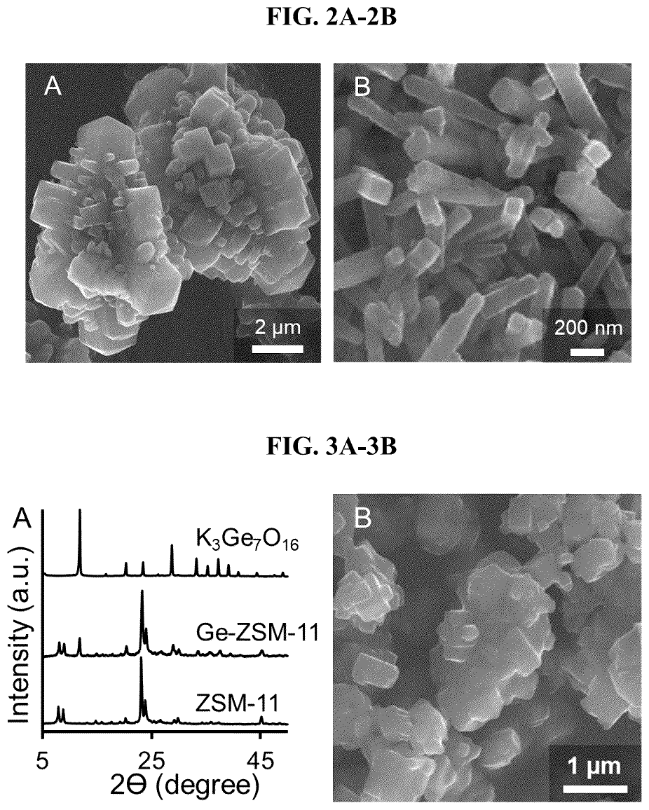

FIG. 3A shows powder X-ray diffraction patterns showing the crystallinity of ZSM-11, Ge-ZSM-11, and K₃Ge₇O₁₆ (from direct synthesis). FIG. 3B shows scanning electron micrograph of K₃Ge₇O₁₆ crystals prepared from a MEL synthesis where both Si and Al sources are removed.

Powder XRD patterns of as-synthesized Ge-ZSM-11 contain peaks corresponding to an impurity (FIG. 3A), consistent with the minor population of cubic GeₓO_{y} species in electron micrographs. These species appear within 24 hours of synthesis (FIG. 3B) and remain in the sample throughout the remaining period of hydrothermal treatment. Direct synthesis of GeₓO_{y} species using the identical conditions of MEL synthesis, but without the addition of Si and Al sources, yielded an aggregated crystalline product (FIG. 3B) with a powder XRD pattern that matches that of the impurity peaks in Ge-ZSM-11 (FIG. 2A), which were confirmed to be K₃Ge₇O₁₆. Treatment in water is sufficient to dissolve this structure, thereby purifying Ge-ZSM-11 (as indicated by the loss of the impurity peak in powder XRD patterns of washed samples, FIG. 1D).

Time-elapsed powder XRD patterns of ZSM-11 and Ge-ZSM-11 (FIG. 1E) and textural analysis clearly show that the incorporation of GeO₂ in the synthesis reduces crystallization time from 3 to 2 days. During the disorder-to-order transition of amorphous (alumino)silicate precursors, electron microscopy images of extracted solids reveal that the K₃Ge₇O₁₆ impurity phase appears after 1 day of heating. After aging at room temperature, the Si/Al ratio in the amorphous solid reaches a value equal to that of the final zeolite product. Interestingly, the majority of Ge remains within the supernatant or K₃Ge₇O₁₆ impurity that is removed with post-synthesis washing, leaving only a small fraction within the zeolite product (Si/Ge>100). This seems to indicate the impact of GeO₂ on MEL crystallization is not primarily attributed to its role as a heteroatom, but more so as a modifier that acts by a mechanism that is not fully understood. The effects of GeO₂ are observed even before the onset of nucleation where SEM images reveal changes in the nature of amorphous precursors from nanoparticles (without GeO₂) to what appears to be a continuous amorphous phase in the presence of GeO₂. For Ge-ZSM-11, time-resolved SEM images of extracted solids at periodic stages of synthesis show crystals emerging from the amorphous phase, similar to what was recently observed for self-pillared pentasils.

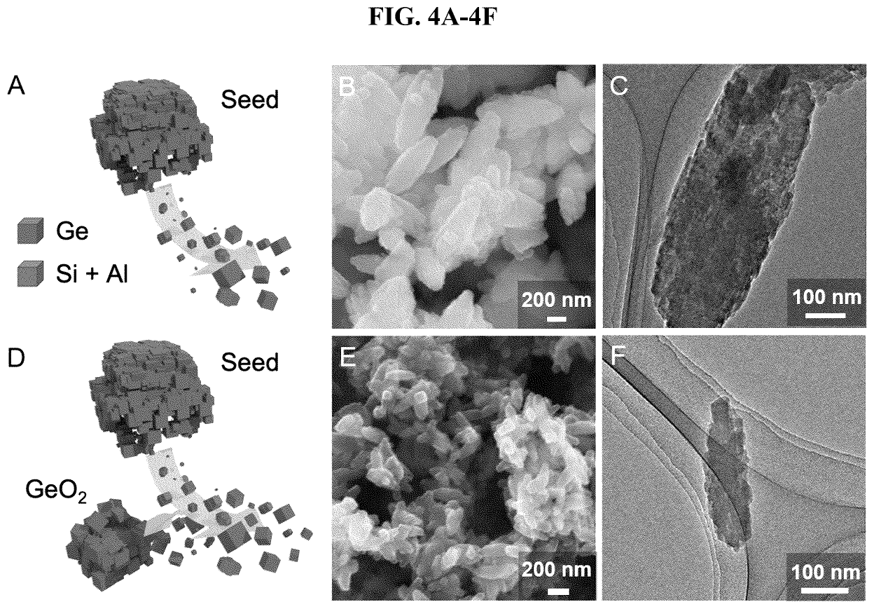

Previous studies have shown that seeded growth of ZSM-11 can lead to a reduction in crystal size relative to its counterpart obtained by non-seeded synthesis. Here this effect was assessed using two different seed-assisted synthesis protocols wherein the temperature of hydrothermal treatment was reduced from 160 to 120° C. to take advantage of seed promotion of zeolite crystallization. FIG. 4 shows seeded synthesis of ZSM-11. FIG. 4A shows an exemplary scheme showing the dissolution of Ge-zeolite seeds, releasing Ge species into a growth medium that is initially Ge-free. FIG. 4B shows a scanning electron micrograph of ZSM-11_{seed}. FIG. 4C shows a transmission electron micrograph of a representative ZSM-11_{seed} crystal. FIG. 4D shows a scheme showing the dissolution of Ge-zeolite seeds, releasing Ge species into a growth medium that contains GeO₂. FIG. 4E shows a SEM image of Ge-ZSM-11_{seed}. FIG. 4F shows a TEM image of a representative Ge-ZSM-11_{seed} crystal.

In a first approach, Ge-ZSM-11 crystals (FIG. 2B) were added as seeds in a growth mixture that lacked any additional GeO₂ (FIG. 4A). As shown in FIG. 4B, the resulting ZSM-11_{seed} crystals have an ellipsoidal morphology that differs from the rod-shaped morphology of parent seed crystals. The size of crystals obtained by seeded growth was 200-300 nm (FIG. 4C). In the second approach, the same seeded growth experiment was performed with the addition of GeO₂ to the growth mixture (FIG. 4D). In the presence of additional GeO₂, similar ellipsoidal particles were obtained but with a markedly reduced crystal size of <100 nm (FIGS. 4E and 4F) that exhibits a single crystal nature. These appear to be the smallest MEL-type crystals reported in literature. The purity and crystallinity of both seed-assisted materials were confirmed by powder X-ray diffraction. Elemental analysis of the ultrasmall crystals after washing to remove K₃Ge₇O₁₆ impurity revealed a Si/Ge ratio of >500 and similar aluminum content (Si/Al=28) compared to the Ge-free sample (Table 1).

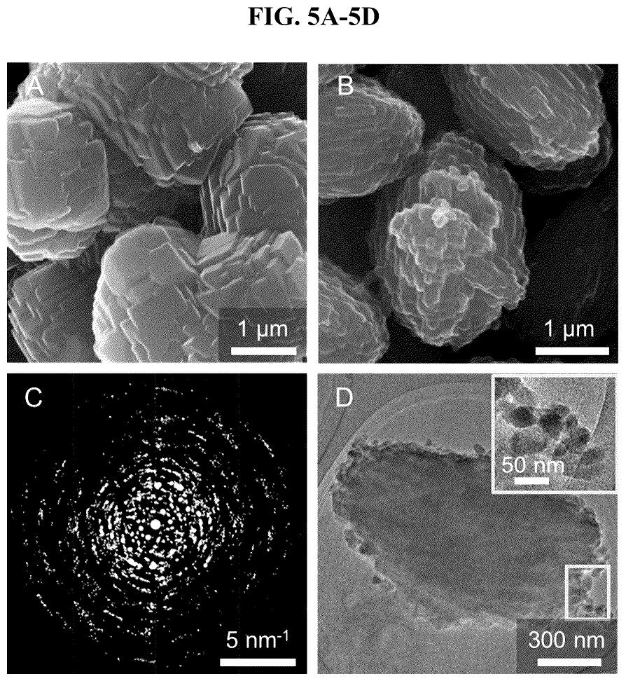

Crystallization of MEL-type materials and many others (e.g. MFI) with high Al content (Si/Al<20) do not commonly result in nanosized materials. To this end, the robustness of Ge-modification was tested under conditions of higher aluminum concentrations using a synthesis protocol that yields MEL-type materials with Si/Al≈15 (compared to Si/Al=28-35 for previous samples). These syntheses required a shift in the organic structure-directing agent from diaminooctane to tetrabutylammonium (TBA⁺). FIG. 5 shows electron microscopy analysis of Al-rich ZSM-11. FIG. 5A shows scanning electron micrograph of a ZSM-11_{Al-rich} sample. FIG. 5B shows a SEM image of a Ge-ZSM-11_{Al-rich} sample. FIG. 5C shows an electron diffraction pattern of Ge-ZSM-11_{Al-rich} showing evidence of polycrystallinity. FIG. 5D shows a TEM image of a representative Ge-ZSM-11_{Al-rich} particle with individual nanocrystals (Inset in FIG. 5D).

Preparation of ZSM-11 in more Al-rich conditions without the addition of GeO₂ resulted in crystals with average sizes >2 μm (FIG. 5A). The morphology of these crystals are aggregates of single crystals. The same synthesis repeated with the addition of GeO₂ resulted in particles with an apparent size (FIG. 5B) equivalent to that obtained from the Ge-free synthesis; however, higher resolution images show much smaller features. This is consistent with reconstructed 3-dimensional electron diffraction patterns of these samples (FIG. 5C) reveal polycrystallinity. HRTEM images confirm that Ge-ZSM-11 particles are aggregates comprised of individual, nano-sized crystals with an average dimension 20-30 nm (FIG. 5D).

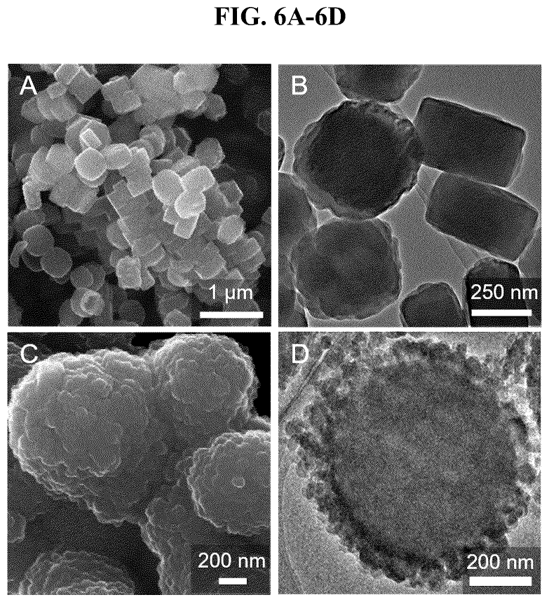

To further test the generalizability of this strategy, ZSM-5 (MFI) synthesis was performed in the absence and presence of GeO₂. Zeolite MFI was prepared using tetrapropylammonium (TPA⁺) as the organic structure-directing agent. FIG. 6 shows characterization of ZSM-5 synthesized with and without GeO₂. FIG. 6A shows a scanning electron micrograph of ZSM-5. FIG. 6B shows a transmission electron micrograph of ZSM-5 showing rough features that are characteristic of crystallization by amorphous precursor attachment. FIG. 6C shows an idealized scheme of protrusions during nonclassical (3-dimensional) growth of MFI type crystal surfaces. FIG. 6C shows a SEM image of Ge-ZSM-5 showing a highly corrugated particle surface. FIG. 6D shows a TEM image of a representative Ge-ZSM-5 particle showing evidence of growth by either colloidal assembly or (nearly)oriented attachment.

Synthesis of ZSM-5 in Ge-free media results in relatively uniform crystals with a disk-like morphology (FIGS. 6A and 6B). Powder XRD patterns (FIG. 1E) and electron diffraction pattern of ZSM-5 confirm its crystallinity. SEM images show that a fraction of particles contain contours that are indicative of crystallization by particle attachment (CPA), which is well-known for MFI-type materials. The same synthesis with the addition of GeO₂ leads to Ge-ZSM-5 particles with an abnormally rough exterior surface (FIG. 6C). These particles closely resemble finned zeolites obtained from seed-assisted protocols where small protrusions epitaxially grow on the surfaces of parent seeds. HRTEM images reveal that the Ge-ZSM-5 particles are comprised of small crystallites on the periphery of larger particles (FIG. 6D). The particulates do not appear to be protrusions, but rather individual (spheroidal) particles populating the outer surface. Accordingly, ZSM-5 crystals are essentially made up of two types of crystals: large crystals with size of about 1 μm and nano-sized crystals with dimensions less than 100 nm on the surface of the larger crystals. Thus, GeO₂ addition in ZSM-5 synthesis leads to attachment of nano-sized (<100 nm) crystals on the surface of core crystals. The curvature generated at the interface between the interior (larger) particle and exterior (smaller) crystallites is indicative of colloidal assembly or oriented attachment mechanisms of nonclassical crystallization, which are known pathways for MFI-type crystals.

Comparison of ZSM-11 (MEL) and ZSM-5 (MFI) syntheses in the presence of GeO₂ reveals different effects, which seemingly suggests different roles of Ge species as a function of zeolite structure or synthesis condition. In all cases it appears Ge influences zeolite formation in a way that avoids heteroatom incorporation, as indicated by the relatively low amount of Ge in the final products (Table 1). Although the exact mechanism of action is unknown, the role of Ge in these syntheses differs from more conventional functions outlined in FIG. 1A where Ge incorporation as framework sites is critical. For ZSM-11, the presence of Ge in the growth medium appears to promote nucleation based on observation of a larger population of crystals with smaller size in comparison to crystals prepared in Ge-free media. For ZSM-5, the effect of Ge on nucleation leads to a heterogeneous distribution of particle sizes wherein processes of colloidal aggregation and/or oriented attachment are evident by the formation of aggregates. Time-resolved ex situ imaging of solids extracted at periodic heating times shows that ZSM-5 synthesis in the absence of GeO₂ produces rough particles that become less corrugated with heating time. This is consistent with a previous study of MFI-type zeolites showing that their nonclassical pathways of crystallization are obscured at later times due to ripening and densification; however, in the presence of GeO₂ it is posited that these processes are inhibited owing to the preservation of rough features throughout crystallization.

### EXAMPLE 2

Catalytic testing. All synthesized materials were tested as methanol-to-hydrocarbon (MTH) catalysts. Prior to reaction, the proton-form of zeolites were sieved into pellets of size 250 to 400 μm (40-60 mesh size). The zeolite pellets (20 mg) were mixed with silica gel (inert, 60 mg, 50-70 mesh size) and placed in a ¼ in reactor tube, supported with quartz wool at the top and bottom of the catalyst bed. The catalyst was pretreated in presence of synthetic air (30 sccm) to remove any adsorbed species. The pretreatment temperature profile included heating the catalyst bed to 250° C. at 2° C./min, holding at 250° C. for 2 h, then ramping to 550° C. at same rate. The catalyst bed was pretreated at 550° C. for 4 h and then returned to the reaction temperature of 350° C. Once the reaction temperature was reached, the bed was purged with Ar for 1 h before flowing methanol. Ar was used as the carrier gas for the reaction at flow rate of 50 sccm. A bypass line was used to achieve a steady flow rate of methanol through the reactor system prior to the reaction. Once the feed stabilized, MTH reaction was performed at different weight hourly space velocities (whsv), depending upon the catalysts. The space velocities used for ZSM-5, ZSM-11, ZSM-11_{seed}, and ZSM-11_{Al-rich} catalysts with their corresponding Ge-containing samples were 50, 31, 36 and 50 h⁻¹, respectively.

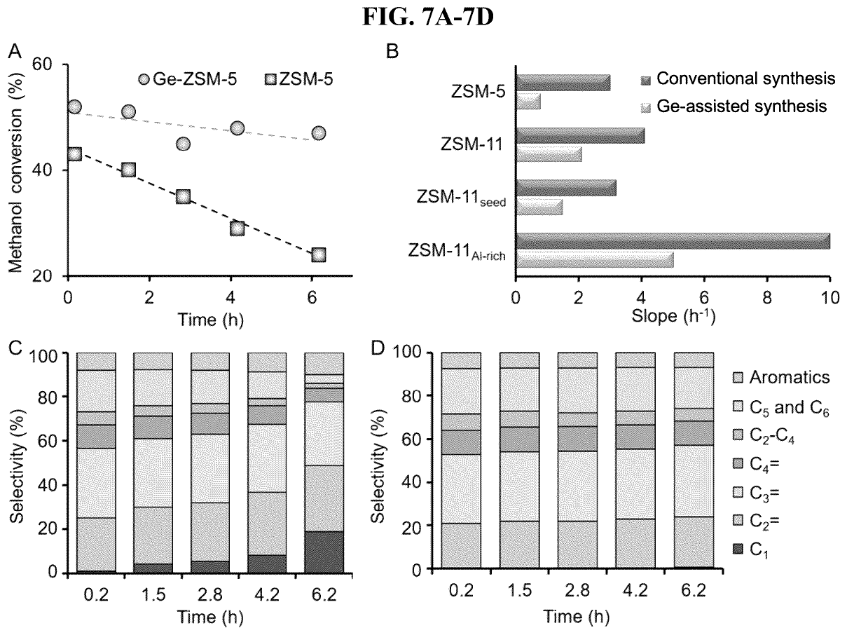

This example assessed the impact of Ge-directed synthesis on the performance of both ZSM-11 and ZSM-5 as catalysts using methanol to hydrocarbons as a benchmark reaction. Conventional methods were used to prepare each zeolite in proton (H) form and quantify Brøsnsted and Lewis acid concentrations. The space velocity was adjusted to ensure sub-complete methanol conversion for all reactions. FIG. 7A shows methanol conversion as a function of time on stream for H-form ZSM-5 (squares) and Ge-ZSM-5 (circles) catalysts in a methanol-to-hydrocarbon (MTH) reaction carried out at 350° C., 1 atm, and WHSV=50 h⁻¹. Solid lines are linear regression used to obtain the rate of deactivation (slope with units of h⁻¹). FIG. 7B shows a comparison of deactivation rates from reactions at sub-complete methanol conversion for zeolites synthesized with and without GeO₂. Elemental analysis of the former reveal only trace amounts of Ge in the catalyst (Table 1). FIGS. 7C and 7D show total product selectivities for catalysts (C) ZSM-5 and (D) Ge-ZSM-5 as a function of time on stream at sub-complete conversion.

Comparison of time-on-stream conversion over MFI-type catalysts prepared with (Ge-ZSM-5) and without (ZSM-5) germanium reveal a 3.8-fold reduction in the rate of deactivation (FIG. 7A), which is comparable to the improved performance of finned ZSM-5 catalysts relative to conventional analogues. Additional comparisons were made between other zeolites in Table 1 that were prepared from synthesis mixtures with and without GeO₂ where longer lifetimes were observed for every Ge-assisted zeolite (FIG. 7B). The most significant improvement in catalyst lifetime was observed for Ge-ZSM-5, whereas all Ge-ZSM-11 samples exhibited at least 2-fold reduction in deactivation rates. The reduced crystal size as a result of Ge-assisted synthesis reduces mass transport limitations, which improves catalyst performance. This is also reflected in product selectivities as a function of time on stream where the emergence of methane is an indicator of catalyst deactivation and higher ethene selectivity is indicative of larger particles. This is evident for ZSM-5 (FIG. 7C) where higher ethene yield and the emergence of methane was observed at shorter time on stream compared to the trends observed for Ge-ZSM-5 (FIG. 7D).

### REFERENCES

The following documents are incorporated by referenced herein.
ADDIN EN.REFLIST [1] a) S. Mintova, J.-P. Gilson, V. Valtchev, Nanoscale 2013, 5, 6693; b) A. Feliczak-Guzik, Micropor. Mesopor. Mat. 2018, 259, 33; c) E. Koohsaryan, M. Anbia, Chinese J. Catal. 2016, 37, 447.
[2] Y. Shen, T. T. Le, D. Fu, J. E. Schmidt, M. Filez, B. M. Weckhuysen, J. D. Rimer, ACS Catal. 2018, 8, 11042.
[3] S. Li, J. Li, M. Dong, S. Fan, T. Zhao, J. Wang, W. Fan, Chem. Soc. Rev. 2019, 48, 885.
[4] a) S. Mintova, J. Grand, V. Valtchev, C R Chim 2016, 19, 183; b) L. Burel, A. J. M. Tuel, Micropor. Mesopor. Mat. 2013, 174, 90; c) I. Schmidt, C. Madsen, C. J. Jacobsen, Inorg. Chem. 2000, 39, 2279; d) E.-P. Ng, D. Chateigner, T. Bein, V. Valtchev, S. Mintova, Science 2012, 335, 70.
[5] a) R. Chal, C. Gerardin, M. Bulut, S. van Donk, ChenCatChem 2011, 3, 67; b) K. Li, J. Valla, J. Garcia-Martinez, ChemCatChem 2014, 6, 46.
[6] a) R. Jain, A. Chawla, N. Linares, J. Garcia Martinez, J. D. Rimer, Adv. Mater. 2021, 33, 2100897; b) X. Zhang, D. Liu, D. Xu, S. Asahina, K. A. Cychosz, K. V. Agrawal, Y. Al Wahedi, A. Bhan, S. Al Hashimi, O. Terasaki, Science 2012, 336, 1684.
[7] H. Dai, Y. Shen, T. Yang, C. Lee, D. Fu, A. Agarwal, T. T. Le, M. Tsapatsis, J. C. Palmer, B. M. Weckhuysen, Nat. Mater. 2020, 19, 1074.
[8] K. Varoon, X. Zhang, B. Elyassi, D. D. Brewer, M. Gettel, S. Kumar, J. A. Lee, S. Maheshwari, A. Mittal, C.-Y. Sung, Science 2011, 334, 72.
[9] P.-S. Lee, X. Zhang, J. A. Stoeger, A. Malek, W. Fan, S. Kumar, W. C. Yoo, S. Al Hashimi, R. L. Penn, A. Stein, J. Am. Chem. Soc. 2011, 133, 493.
[10] J. Garcia-Martinez, M. Johnson, J. Valla, K. Li, J. Y. Ying, Catal. Sci. Technol. 2012, 2, 987.
[11] a) E. Nikolla, Y. Romin-Leshkov, M. Moliner, M. E. Davis, ACS Catal. 2011, 1, 408; b) A. J. Jones, R. T. Carr, S. I. Zones, E. Iglesia, J. Catal. 2014, 312, 58.
[12] D. Parmar, Z. Niu, Y. Liang, H. Dai, J. D. Rimer, Faraday Discuss. 2022.
[13] a) J. Sun, C. Bonneau, Á. Cantín, A. Corma, M. J. Díaz-Cabanas, M. Moliner, D. Zhang, M. Li, X. Zou, Nature 2009, 458, 1154; b) P. Lu, A. Mayoral, L. Gomez-Hortiguela, Y. Zhang, M. A. Camblor, Chem. Mater. 2019, 31, 5484; c) J. D. Rimer, D. D. Roth, D. G. Vlachos, R. F. Lobo, Langmuir 2007, 23, 2784.
[14] L. Xu, M. K. Choudhary, K. Muraoka, W. Chaikittisilp, T. Wakihara, J. D. Rimer, T. Okubo, Angew. Chem. 2019, 131, 14671.
[15] P. Eliášová, M. Opanasenko, P. S. Wheatley, M. Shamzhy, M. Mazur, P. Nachtigall, W. J. Roth, R. E. Morris, J. Čejka, Chem. Soc. Rev. 2015, 44, 7177.
[16] M. Opanasenko, M. Shamzhy, Y. Wang, W. Yan, P. Nachtigall, J. Čejka, Angew. Chem. 2020, 59, 19380.
[17] Y. Shen, T. T. Le, R. Li, J. D. Rimer, ChemPhysChem 2018, 19, 529.
[18] A. Ghorbanpour, A. Gumidyala, L. C. Grabow, S. P. Crossley, J. D. Rimer, ACS Nano 2015, 9, 4006.
[19] a) M. Kumar, H. Luo, Y. Romãn-Leshkov, J. D. Rimer, J. Am. Chem. Soc. 2015, 137, 13007; b) N. Ren, S. Bosnar, J. Broni\tilde{c}, M. Dutour Sikiri\tilde{c}, T. Miši\tilde{c}, V. Svetliči\tilde{c}, J.-J. Mao, T. Antoni\tilde{c} Jeli\tilde{c}, M. Hadžija, B. Subotić, Langmuir 2014, 30, 8570.
[20] M. K. Choudhary, M. Kumar, J. D. Rimer, Angew. Chem. 2019, 131, 15859.
[21] D. Li, M. H. Nielsen, J. R. Lee, C. Frandsen, J. F. Banfield, J. J. De Yoreo, Science 2012, 336, 1014.
[22] M. Kumar, M. K. Choudhary, J. D. Rimer, Nat. Commun. 2018, 9, 1.
[23] K. N. Bozhilov, T. T. Le, Z. Qin, T. Terlier, A. Palčić, J. D. Rimer, V. Valtchev, Sci. Adv. 2021, 7, eabg0454.
[24] D. Parmar, S. H. Cha, T. Salavati-Fard, A. Agarwal, H. Chiang, S. M. Washburn, J. C. Palmer, L. C. Grabow, J. D. Rimer, J. Am. Chem. Soc. 2021.
[25] J. Li, M. Liu, S. Li, X. Guo, C. Song, Ind. Eng. Chem. Res. 2019, 58, 1896.
[26] a) G. Fagerlund, Matériaux et Construction 1973, 6, 239; b) S. Storck, H. Bretinger, W. F. Maier, Appl. Catal. A: Gen. 1998, 174, 137.
[27] M. O. Cichocka, J. Ångström, B. Wang, X. Zou, S. Smeets, J. Appl. Crystallogr. 2018, 51, 1652.
[28] W. Wan, J. Sun, J. Su, S. Hovmöller, X. Zou, J. Appl. Crystallogr. 2013, 46, 1863.
[29] D. N. Mastronarde, S. R. Held, J. Struct. Biol. 2017, 197, 102.

What is claimed is:

1. A method for synthesizing nano-sized zeolites, comprising:
preparing a synthesis mixture comprising silica, aluminum and germanium, wherein a ratio of silica to germanium in the synthesis mixture is at least 10;
heating the synthesis mixture to a temperature between 100° C. and 200° C.;
allowing nano-sized zeolites to form in the synthesis mixture;
isolating zeolites from the synthesis mixture; and
washing the zeolites isolated from the synthesis mixture, wherein the zeolites isolated from the synthesis mixture comprise nano-sized zeolites, and wherein a ratio of silica to germanium in the nano-sized zeolites after washing is at least 100.

2. The method of claim 1, wherein the synthesis mixture further comprises one or more of 1,8-diaminooctane, tetrabutylammonium bromide, and tetrapropylammonium hydroxide as an organic structure directing agent.

3. The method of claim 1, further comprising a step of adding nano-sized zeolite crystals comprising germanium to the synthesis mixture as seed crystals.

4. The method of claim 1, further comprising a step of annealing the nano-sized zeolites after isolating.

5. The method of claim 1, further comprising a step of calcining the nano-sized zeolites after isolating to remove organic templates and produce calcined zeolites.

6. The method of claim 5, further comprising a step of ion exchanging the calcined zeolites to produce proton-form nano-sized zeolites.

7. The method of claim 1, wherein a ratio of silica to aluminum in the nano-sized zeolites is 15 to 30.

8. The method of claim 1, wherein the nano-sized zeolites are MEL type or MFI type.

9. The method of claim 1, further comprising a step of recovering germanium from the synthesis mixture after isolating the zeolites.

10. The method of claim 1, further comprising a step of recovering germanium from the synthesis mixture after washing the zeolites.

11. The nano-sized zeolites prepared by the method of claim 1.

12. A catalyst comprising the nano-sized zeolites prepared by the method of claim 1.

13. A method for preparing or converting an organic compound comprising contacting the organic compound with the catalyst of claim 12.

14. The method of claim 13, wherein the method for preparing or converting an organic compound further comprises performing alkylation, Fischer-Tropsch synthesis, methanol or methane upgrading, cracking, or biomass conversion.

15. Nano-sized zeolite crystals, comprising:
silica;
aluminum; and
germanium, wherein a ratio of silica to germanium in the nano-sized zeolite crystals is at least 100, and wherein the nano-sized zeolite crystals have dimensions less than 100 nm.

16. The nano-sized zeolite crystals of claim 15, wherein a ratio of silica to aluminum in the nano-sized zeolite crystals is 15 to 30.

17. A synthesis mixture for the synthesis of nano-sized zeolite crystals, comprising:
silica;
aluminum; and
germanium, wherein a ratio of silica to germanium in the synthesis mixture is at least 10.

18. The synthesis mixture of claim 17, wherein the synthesis mixture further comprises one or more of 1,8-diaminooctane, tetrabutylammonium bromide, and tetrapropylammonium hydroxide as an organic structure directing agent.
